(19) United States
(12) Patent Application Publication
(10) Pub. No.: US 2022/0214084 A1
(43) Pub. Date: Jul. 7, 2022

(54) A Thermal-Compression Heat Pump With Four Chambers Separated by Three Regenerators

(71) Applicant: ThermoLift, Inc., Stony Brook, NY (US)

(72) Inventors: Peter Hofbauer, West Bloomfield, MI (US); YueXin Huang, Novi, MI (US)

(21) Appl. No.: 17/604,514

(22) PCT Filed: Apr. 30, 2020
(86) PCT No.: PCT/IB2020/054113

§ 371 Date: Oct. 18, 2021

Related U.S. Application Data
(60) Provisional application No. 62/841,938, filed on May 2, 2019.

(51) Int. Cl. F25B 30/02; F02G 1/044

(52) U.S. Cl. CPC F25B 30/02; F25B 9/14; F02G 1/0445

(57) ABSTRACT

A tubular reactor which acts as a combustor and heat exchanger is disclosed. Such reactor supplants a system with a combustor having a heat exchanger arranged around the combustor. The combined system includes a diffuser having an inlet for a fuel-and-air mixture and a plurality of holes defined in its surface through which the fuel-and-air mixture exits the diffuser and a plurality of tubes. First linear portions along the length of each tube are mutually parallel with a centerline of the first portions of the tubes displaced from the diffuser by a predetermined distance. Centerlines of the linear portions of adjacent tubes are displaced from each other by a predetermined gap. The fuel and air combust in the proximity of the first portion of the tubes for effective heat transfer to gases traveling through the tubes. Such a tubular reactor can be employed within a thermal-compression heat pump.

### FIELD

The present disclosure relates to a tubular reactor that can be used in a heat pump, heat engine, or other thermodynamic apparatus.

### BACKGROUND

One example of a thermodynamic apparatus, a compression-expansion heat pump 200, is shown in FIG. 1. Heat pump 200 has a hot heat exchanger 202, a cylinder 204 in which a hot displacer 206 reciprocates and a cylinder 208 in which a cold displacer 210 reciprocates. Mechatronics actuators, in mechatronics section 220, are coupled to hot and cold displacers 206 and 210 and drive the displacers between ends of travel. A low molecular weight gas, such as helium, is contained within cylinders 204 and 208 and inside tubes of hot heat exchanger 202. There is a hot chamber 276 delimited by dome 278, cylinder walls 280, and a top surface of displacer 206. There is also a warm-hot chamber, which is not visible in FIG. 1 since displacer 206 is shown in its lower position in FIG. 1. The warm-hot chamber is located between mechatronics section and displacer 206. A cold chamber 280 below cold displacer 210 is visible in FIG. 1; although a cold-warm chamber is not visible due to displacer 210 being shown in its upper position. When displacers 206 and 210 are caused to reciprocate, the working gas moves among cold chamber 280, hot chamber 276, the warm-hot chamber, and the warm-cold chamber. The working gas accesses the various chambers by traveling through regenerators and/or heat exchangers located in an annular space located outside of cylinders 204 and 208. When hot displacer 206 moves upward toward hot heat exchanger 202, the working gas flows: from tubes of hot heat exchanger 202 into a regenerator 230; from regenerator 230 flow into a warm-hot heat exchanger 240; and from the warm-hot heat exchanger into the warm-hot chamber. When hot displacer 206 moves the other direction, flow is reversed compared to that described above.

In regard to movement of cold displacer 210, working fluid moves between the volume within cylinder 208 below cold displacer 210 (away from mechatronics section 220) and a cold heat exchanger 260; between cold heat exchanger 260 and a cold regenerator 270; between cold regenerator 270 and a warm-cold heat exchanger 250; and between cold warm-cold heat exchanger 250 and the warm-cold chamber.

One of the fluids passing through heat exchangers 240, 250, and 260 is the working fluid. The other fluid in the present example is a liquid coolant. In regard to warm-hot heat exchanger 240, coolant accesses passageways of warm-hot heat exchanger 240 through inlet 242 and exits through outlet 244. Similarly, passages of warm-cold heat exchanger 250 are coupled to an inlet 252 and an outlet 254; and passages of cold heat exchanger 260 are coupled to an inlet 262 and an outlet 264.

Air and fuel are provided to heat pump 200 via a blower 270. Premixed air and fuel are routed through a heat exchanger for preheating by exhaust gases leaving heat pump 200. It is a rather convoluted path that is not described here. However, the air and fuel are provided to a wire-mesh diffuser/combustor 272 through an inlet 274. Wire-mesh diffuser/combustor 272 has opening on the outer surface that prevent blow back of combustion into the interior of combustor 272. Diffuser/combustor 272 acts as a combustion holder with fuel oxidizing near an outer surface of diffuser/combustor 272. Diffuser/combustor 272 gets very hot and radiates to tubes of hot heat exchanger 202. The tubes are U-shaped with one side of the one of the legs of the U nearer diffuser/combustor 272, with a better shape factor for radiation. Surface area of the tubes is ill used to effect heat transfer to the helium flowing therethrough because the one surface of the inner leg of the tubes face diffuser/combustor 272 sets a limit to how much air and fuel can be combusted due to its melting or softening temperature. And, the other tube surfaces to which there is limited radiation are insufficiently hot to promote effective heat transfer to the helium.

It is desirable to have a combustion system that uses the surface area of the tubes more uniformly for heat transfer than the combustion system of FIG. 1.

### SUMMARY

To overcome at least one problem in the prior art a tubular reactor is disclosed that has: a diffuser having an inlet for a fuel-and-air mixture and a plurality of holes defined in its surface through which the fuel-and-air mixture exits the diffuser; and a plurality of tubes. A first portion along the length of each tube is linear. A centerline of the first portion of each of the tubes is displaced from an outer surface of the diffuser by a first predetermined displacement. The centerline of the first portion of each tube is spaced from the centerline of the first portion of each adjacent tube by a predetermined gap. A second portion along the length of each tube is U shaped. The U-shaped portion can be curved through the length that is U shaped or, alternatively, can have two curved portions with a straight portion therebetween.

The first portion of each of the tubes is mutually parallel with all other first portions of the tubes. A third portion along the length of each tube is linear and a center line of the third portion is displaced from the outer surface of the diffuser by a second predetermined displacement. The first and third portions of each tube are fluidly coupled via the second portion of the tube. The first portion of the tube is fluidly coupled with a first chamber. The third portion of the tube is fluidly coupled with a second chamber. In some embodiments the first chamber is a hot chamber in a heat pump and the second chamber has a regenerator disposed therein.

The plurality of tubes is a first plurality of tubes. The tubular reactor further includes a second plurality of tubes with a first linear portion of the length of each of the second plurality of tubes mutually parallel. A centerline of the first portion of each of the tubes of the second plurality of tubes is displaced from an outer surface of the diffuser by a second predetermined displacement. The second predetermined displacement is greater than the first predetermined displacement.

In some embodiments, the predetermined gap is based on a quench distance.

The tubular reactor includes a reflective cylinder with a majority of the first and second portions of the tubes disposed inside the reflective cylinder.

The tubular reactor also has an ignitor disposed between the first and third portions of the tubes.

In some embodiments, the tubular reactor also includes a mesh of a material having a melting temperature greater than a predetermined threshold adhered to the first portion of the tubes. In other embodiments, a porous media is adhered to the first portion of the tubes wherein the porous media has a melting temperature greater than a predetermined threshold. The predetermined gap is based at least on number of tubes in the plurality of tubes, a cross-sectional area of the tubes, a desired flowrate through the tubes, and an allowable pressure drop through the tubes.

A tubular reactor is disclosed that has a substantially cylindrical diffuser. The diffuser has: an inlet for fuel and air; a plurality of exit holes defined in its cylindrical surface; and a diffuser centerline. The tubular reactor also has: a first plurality of tubes and a second plurality of tubes. A centerline of a first linear portion of each tube of the first plurality of tubes intersects a first circle of a first diameter. The centerlines of the first linear portion of each tube of the first plurality of tubes is evenly arranged on the first circle. A centerline of a first linear portion of each tube of the second plurality of tubes intersects a second circle of a second diameter. The centerlines of the second linear portion of each tube of the second plurality of tubes is evenly arranged on the second circle. A centerline of a second linear portion of each tube of the first and second pluralities of tubes intersects a third circle of a third diameter. The second linear portions are evenly arranged on the third circle. The diffuser centerline, a centerline of the first circle, a centerline of the second circle, and a third centerline are coaxial. Each tube has a U-shaped portion that couples the first linear portion to the second linear portion.

The first linear portion of each tube of the first plurality of tubes is offset from adjacent first linear portions of tubes of the first plurality of tubes by a first predetermined gap.

In some embodiment, a catalytic material is provided on an outer surface of the first portion of the tubes of the first plurality of tubes.

The tubular reactor, in some embodiments, a reflective cylinder with a reflective surface on an inside surface of the cylinder. The reflective cylinder has a diameter greater than a diameter of the third circle. A centerline of the reflective cylinder being coaxial with the diffuser.

The tubular reactor has an ignitor disposed between the centerlines of the first and second linear portions of the first plurality of tubes.

The first linear portion of the first and second pluralities of tubes are fluidly coupled to a first chamber via a first transition portion of each of the first and second pluralities of tubes; and the second linear portion of the first and second pluralities of tubes are fluidly coupled to a second chamber via a second transition portion of each of the first and second pluralities of tubes.

In some embodiments, a mesh or a porous media is adhered to the first linear portion of the first plurality of tubes.

Also disclosed is a thermodynamic device that has: a cylinder; a displacer disposed in the cylinder; an actuator that causes the displacer to reciprocate; and a hot chamber delimited by the cylinder, the displacer, and a dome with orifices defined therein. The device has a diffuser having an inlet for a fuel-and-air mixture and a plurality of holes defined in its surface through for the fuel-and-air mixture to exit the diffuser; a regenerator chamber; an ignitor; and a plurality of tubes. A first linear portion along the length of each tube has a centerline which is displaced from an outer surface of the diffuser by a predetermined displacement. The centerline of the linear portion of each tube is displaced from the centerline of the linear portion of each adjacent tube by a predetermined distance. The ignitor is displaced from the diffuser farther than the linear portions of the plurality of tubes. The tubes are fluidly coupled to the hot chamber on a first end and fluidly coupled to the regenerator chamber on a second end. Gas within the tubes moves from the hot chamber into the tubes and from the tubes into the regenerator chamber when the displacer moves toward the dome; and gas within the tubes moves from the regenerator chamber into the tubes and from the tubes into the hot chamber when the displacer moves away from the dome.

An outer surface of the first linear portion of the tubes has one of a porous media and a mesh adhered thereto, in some applications.

The first linear portions of the plurality of tubes are mutually parallel and a distance between adjacent first linear portions of the plurality of tubes is a predetermined gap, in other applications.

In some applications, there is concern that the tubes deform or otherwise move slightly and the gaps between the tubes would become deflected. It is possible that the tubes could move enough that the desired gap is exceeded and flashback onto the diffuser occurs. To retain the tubes as desired, the tubular reactor also includes a cap having a covering portion that rests on the second portion of the plurality of tubes and a cylindrical portion that has a smooth inner surface and a notched outer surface. The annular portion of the cap has an inner edge having an inner diameter and an outer edge having an outer diameter. The cylindrical portion of the cap couples to the annular portion at the inner edge of the annular portion. A number of notches on the notched outer surface equals a number of the plurality of tubes. Each of the first portions of the plurality of tubes engages with a notch on the notched outer surface.

The covering portion of the cap has a cut out defined therein to thereby accommodate installation of an ignitor.

In some embodiments to further control adjustments of the tubes, a ring slid over the third portions of the second plurality of tubes with the ring abutting a surface of the third portions of the second plurality of tubes that is farthest away from the diffuser.

In some embodiments, the tubular reactor includes a fourth portion along the length of the plurality of tubes that is fluidly coupled to the first portion. In cases where that fourth portion is angled or bent in a particular direction to accommodate other aspects of the application, the gap may be greater than the predetermined gap. In such embodiments, a refractory material is stuffed into gaps between adjacent fourth portions of the plurality of the tubes.

### BRIEF DESCRIPTION OF THE DRAWINGS

FIG. 1 is cross section of a compression-expansion heat pump having a combined fuel diffuser and combustor;

FIG. 2 is a cross section of a compression-expansion heat pump having separated fuel diffusing and combusting elements;

FIG. 3 is a cross-section of a combustion and heat exchanger system according to an embodiment of the disclosure;

FIG. 4 is an illustration of a single tube of a combustion/heat exchanger system;

FIG. 5 is an illustration of a cross-section of a combustion and heat exchanger system having a porous media surrounding some of the heat exchanger tubes;

FIGS. 6 and 7 are illustrations of portions of a combustion and heat exchanger system having a mesh next to some of the heat exchanger tubes; and

FIG. 8 is an illustration of a cap that is placed over a U-shaped portion of the tubes;

FIG. 9 is a cross-sectional illustration of the cap of FIG. 8 placed over the U-shaped portion of the tubes;

FIG. 10 shows an embodiment of the assembly of a tubular reactor;

FIG. 11 shows an alternative cap for the tubular reactor; and

FIG. 12 is a view from within the tubular reactor showing insulation material packed into gaps between adjacent tubes in one section along the length of the tubes.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

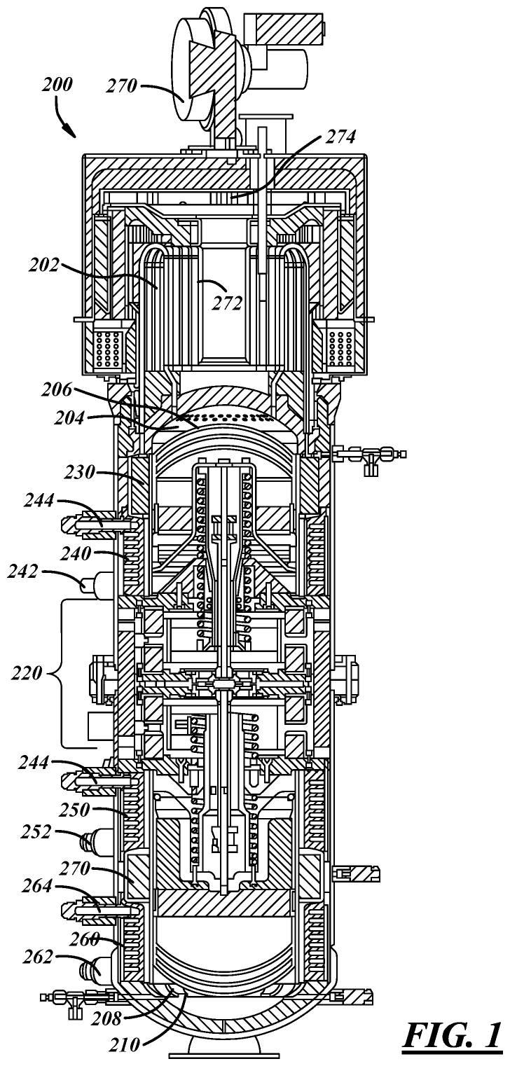

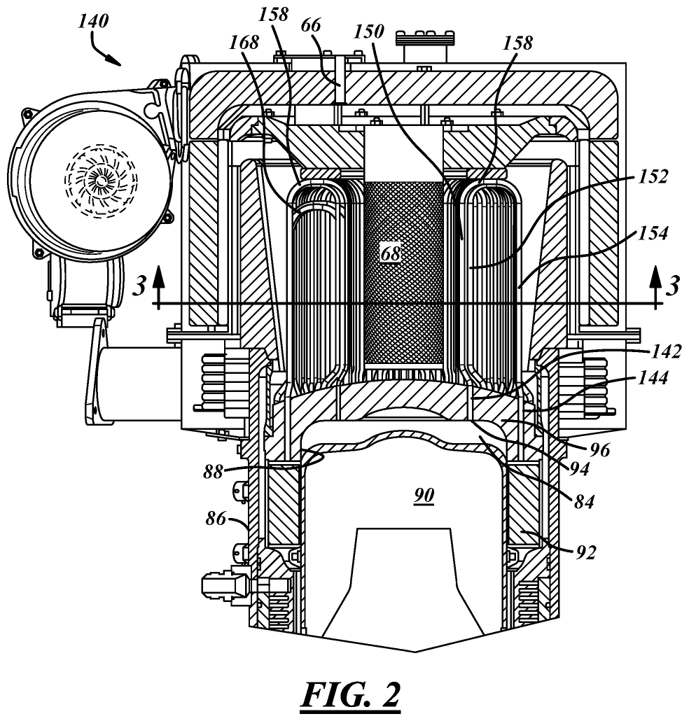

In FIG. 2, an alternative combustion and heat exchange system is shown. An upper portion of a heat pump 140 has a displacer 90 disposed within a cylinder 88. Displacer 90 is coupled to a mechatronics system (not illustrated in FIG. 2), analogous to the system described in FIG. 1, that commands displacer 90 to reciprocate within cylinder 88. The volume of working gas, such as helium or hydrogen, in a hot chamber 84 changes as a result of the movement of displacer 90. When the working gas is pushed out of hot chamber 84, the working gas is pushed into orifices 94 that pass through a dome 96. Orifices 94 are coupled to tubes, each having a first connector section 142 coupled to a first linear portion 150 coupled to a U-shaped portion 158 coupled to a second linear portion 154 coupled to a second connector section 144. Second connector section 144 fluidly couples to a regenerator 92 that is located between a housing 86 and cylinder 88. The space between housing 86 and cylinder 88 is an annulus. Regenerator 92 is annular.

At the center of the tubes is a diffuser 68 to which premixed fuel and air are provided. Diffuser 68 is a cylinder with a plurality of small holes on the outer surface. The diffuser causes the fuel and air to be distributed uniformly to the first linear portion of the tubes 150.

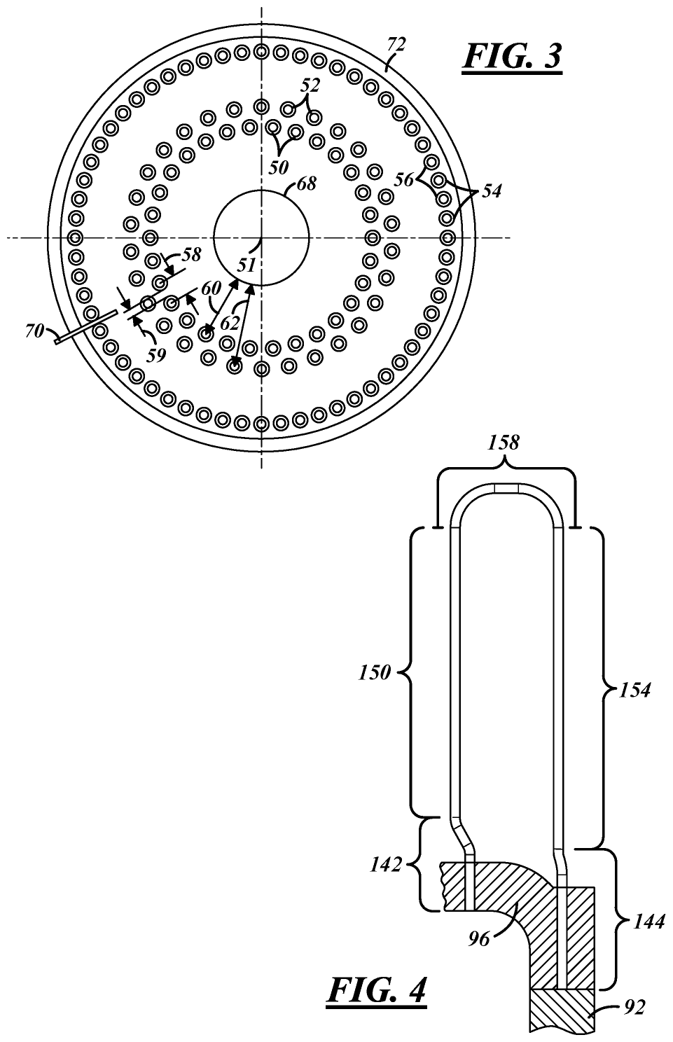

A cross-section of FIG. 2, as indicated by 3-3, is shown in FIG. 3. The cross-section in FIG. 3 is through the entire heat pump 140 (of FIG. 2), not just the cross section of FIG. 2. Diffuser 68 is in the center (center of combustor at 49). At a displacement 60, from the surface of diffuser 68, is a first linear portion of a first plurality of tubes 50. First linear portions 50 are mutually parallel and are displaced from each other centerline to centerline by a distance 58. A gap 59 is the edge to edge distance. Gap 59 is less than or equal to a predetermined gap to avoid flashback. Air and fuel from diffuser 68 travels toward first linear portions 50. It is preferred that there is no combustion occurring between diffuser 68 and first linear portions 50; instead, it is desired for oxidation of the fuel with the air to occur near first linear portions 50. Thus, gap 59 is less than the predetermined gap so that the combustion of oxidation of the fuel and air does not propagate from the side of linear portions 50 that is remote from diffuser 68 toward diffuser 68.

First linear portions of a second plurality of tubes 52 is show in FIG. 3. Referring to FIG. 2, first linear portion 152 of the second plurality of tubes are coupled via a U-shaped portion 158 to second linear portion 154 of the second plurality of tubes. The second plurality of tubes is displaced farther from diffuser 68 than first plurality of tubes (including portions 150, 154, and 158). Now referring to FIG. 3, first linear portions of the second plurality of tubes 52 are viewed in cross section. First linear portions of the second plurality of tubes 54 are mutually parallel. Centerlines of the second plurality of tubes and are displaced from an outer surface of diffuser 68 by a displacement 62. Second linear portions of the first plurality of tubes 54 and second linear portions of the second plurality of tubes 56 are interspersed at the same distance from diffuser 68. Also shown in FIG. 3 is an ignitor 70. A tip of ignitor 70 is positioned between first linear portions of the second plurality of tubes 52 and the second linear portions of the first and second plurality of tubes 54, 56. Such position of ignitor 70 is one non-limiting example.

In some embodiments, a ring 72 is provided that is reflecting on the inner surface. The reflective surface causes radiant energy from tubes 50, 52, 54, and 56 to be reflected onto those same tubes to reduce heat losses from the system.

Referring to FIG. 2, some of the tubes have a lower U-shaped portion 168 than the rest of the tubes that have a U-shaped portion 158. In the embodiment in FIG. 2, the ignitor (not shown) is inserted from the top and extends below the level of U-shaped portions 158. Oxidation of the fuel occurs in the volume between first linear portions 150 and second linear portions 154, more of it occurs next to first linear portions 150 and 152, which causes heat transfer from the oxidizing gases at elevated temperature to the linear portions and the U-shaped portions of the tubes to be more effective than oxidation at other locations. That is, oxidation occurring proximate the tube portions is more effective than oxidation, for example, at a centrally-located burner.

A single tube of the first plurality of tubes is shown in FIG. 4. First connector portion 142 is fluidly coupled to first linear portion 150, which is fluidly coupled to U-shaped portion 158, which is fluidly coupled to second linear portion 154, which is coupled to second connector portion 144.

Combustion is quenched when heat transfer from the combustion zone, e.g., into a solid surface is such that the flame fails to propagate. The quench distance can be determined, for example, by determining the maximum distance that two plates can be displaced from each other which does not allow a flame to propagate therethrough. In the present example, tubes have a gap therebetween which prevents flame propagation. The quench distance depends on the fuel type and the mixture concentration with air. (If the oxidizer is not air, quench distance also depends on the oxidizer composition.) In some embodiments where a range of mixture concentrations and/or fuel types is contemplated, the gap between adjacent tubes is selected for the most demanding condition anticipated in practice.

Depending on the performance goals in designing a heat pump system of other device into which the tubular reactor is employed, the flow of helium, or other low-molecular weight gas, through the tubes is determined. Based on the fluid flow rate, the maximum gap, and the additional considerations that the pressure drop through the tubes shouldn't be excessive and the typical wall thickness of tubes, the number of tubes can be determined. In the embodiment in FIG. 3, two rows of tubes are used to provide sufficient flow cross-sectional area for flowing the helium. In other examples, it is possible that one ring of tubes is sufficient. And in even other examples, more than two rings of tubes are used.

For each tube in FIG. 3, two orifices are formed in dome 96 to accommodate first and second connector sections 142 and 144. A high concentration of orifices in dome 96 weakens the dome. In FIG. 3, first and second connector sections 142 and 144 are bent so that the orifices in dome 96 are less weakening than if arranged close together.

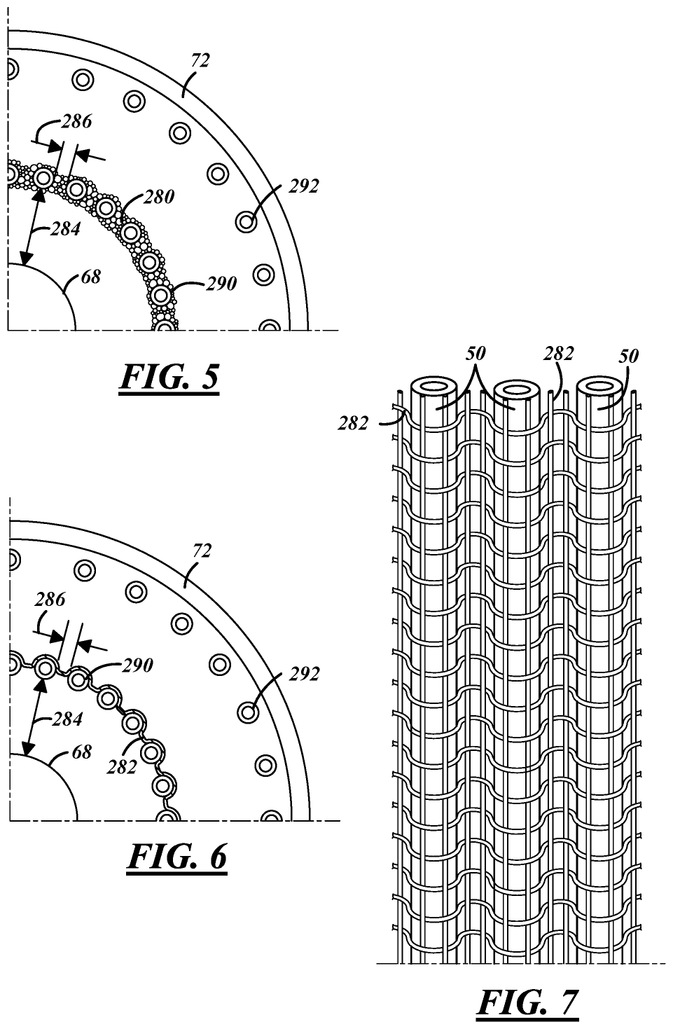

An alternative embodiment is shown in FIG. 5. Diffuser 68 has a ring of tubes 290 arranged at a displacement 284 from the outer surface of diffuser 68. A porous media 280 is arranged on the outer surface of tubes 290. Because of porous media 280, a gap 286 between adjacent tubes 290 can be much greater than gap 58 (FIG. 3) for tubes 50 that has no such porous media. Flame propagation toward diffuser 68 is prevented by porous media 280, i.e., the gaps in the porous media are much smaller than that needed to quench the flame. Instead, gap 286 is determined based on providing sufficient flow through tubes 290 with low pressure drop and preserving strength in the dome through which tubes 290 pass. (Tubes 290 pass through a dome 96 analogously to what is shown in FIG. 4.)

Because arresting the flame (quench), in FIG. 5, is provided by porous media 280, tubes 290 are substantially larger in diameter than tubes 50 of FIG. 3 in which tubes 50 are used for quenching and thus must be spaced close together.

Of course, tubes 290 is an illustration of a cross section of first linear portions of the full tubes. First linear portions 290 are mutually parallel. First linear portions 290 are fluidly coupled to second linear portions 292 via a U-shaped portion, the latter of which is not illustrated in the cross-section in FIG. 5.

A similar embodiment to that in FIG. 5, is shown in FIG. 6, in which gap 286 is not based on a quench distance. Instead, a mesh 282 is adhered to first linear portions 290 of a plurality of tubes that are displaced from the outer surface of diffuser 68. The mesh size of mesh 282 is selected to prevent combustion from propagating toward diffuser 68.

To support alternative fuels and mixture concentrations in practice, one embodiment in FIG. 5 shows a portion of the combustion with tubes 50, 52, 54 and 56. A porous media 280 is provided surrounding tubes 50. Porous media 280 has randomly sized openings that allow fuel and air to pass from the inside of the ring of tubes 50 to the outside for combustion. However, the pore size of porous media 280 is significantly smaller than the gap between adjacent tubes 50.

In an alternative in FIG. 6, a mesh 282 is applied to tubes 50. Mesh 282 is shown on the outer edge of tubes 50. Alternatively, the mesh could be applied on the inner edge of tubes 50. In FIG. 7, a portion of three tubes 50 is shown with the mesh on the surface of tubes 50. The mesh openings are smaller than the gap between adjacent tubes 50. The embodiments in FIGS. 5-7 are more robust to variabilities in the fuel/oxidizer conditions.

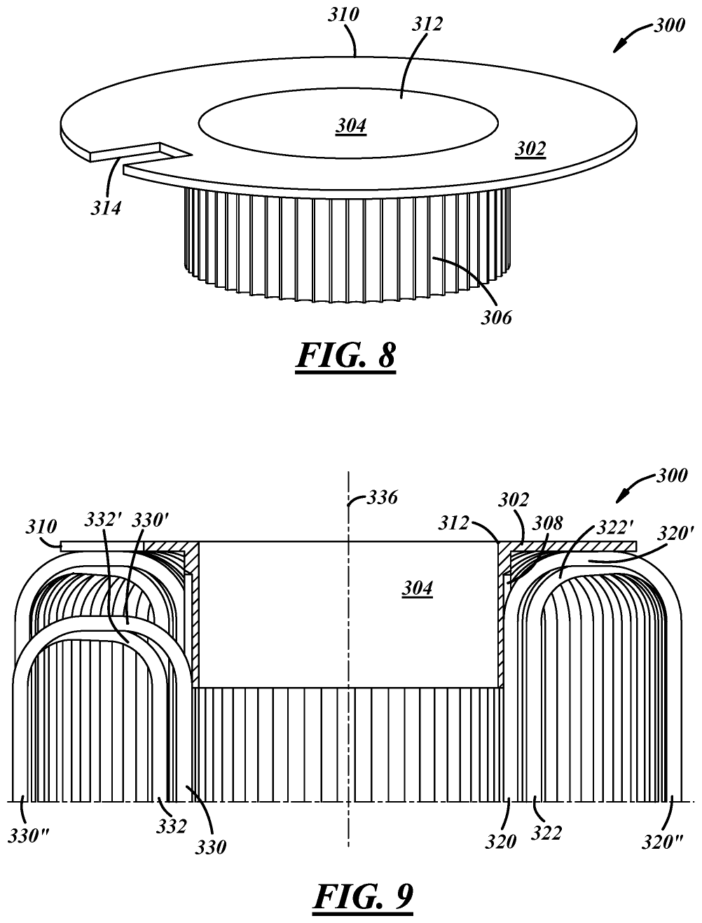

As described above, to prevent flashback from the space beyond tubes 150 of FIG. 2 toward diffuser 68. A consistent gap 59, as seen in FIG. 3, prevents such flashback. In some applications, temperature variations due to warmup, cooldown, and operational range of output can cause the tubes to deflect slightly. To avoid the deflection to becoming more than can be tolerated to prevent flashback, a fixture is applied to maintain the proper gap between adjacent tubes. Such a cap 300 is shown in FIG. 8. Cap 300 has a covering portion 302 that sits atop the U-shaped portion of the tubes. Covering portion 302 is an annulus with an outer edge 310 and an inner edge 312. Inner edge 312 couples to a cylindrical portion 304. Cylindrical portion 304 has an inner surface that is substantially smooth. An outer surface 306 of cylindrical portion 304 has a plurality of notches formed therein. First linear portions 150 of the first plurality of tubes snap into the notches, in one embodiment, with a slight interference fit. A notch is provided for each of first linear portions 150. Also shown in FIG. 8 is a cut out 314 of covering portion 302 to accommodate insertion of an ignitor (not shown).

A portion of a tubular reactor is shown in cross section in FIG. 9 where notches of cap 302 are engaged with first linear portions 320 of the first plurality of tubes. The first plurality of tubes includes linear portion 320, linear portion 320″ and U-shaped portion 320′ that fluidly couples 320 with 320″. Only a portion of notch 308 is visible in FIG. 9 because first portion 320 is engaged with notch 308 over most of the length of notch 308. Shorter tubes are shown on the left-hand side of FIG. 9. A tube has a first linear portion 330, a second linear portion 330″, and a U-shaped portion 330′ that couples linear portions 330 and 330″ together. Another tube that is displaced from the centerline 336 further than the tube including 330, 330′, and 330″ has a first linear portion 332 fluidly coupled to a U-shaped portion 332′. A second linear portion that fluidly couples to U-shaped portion 332′ is barely visible as it is behind second linear portion 330″. The cutout for the ignitor is not visible in cap 300 in the view in FIG. 9. However, it is located above U-shaped portions 330′ and 332′.

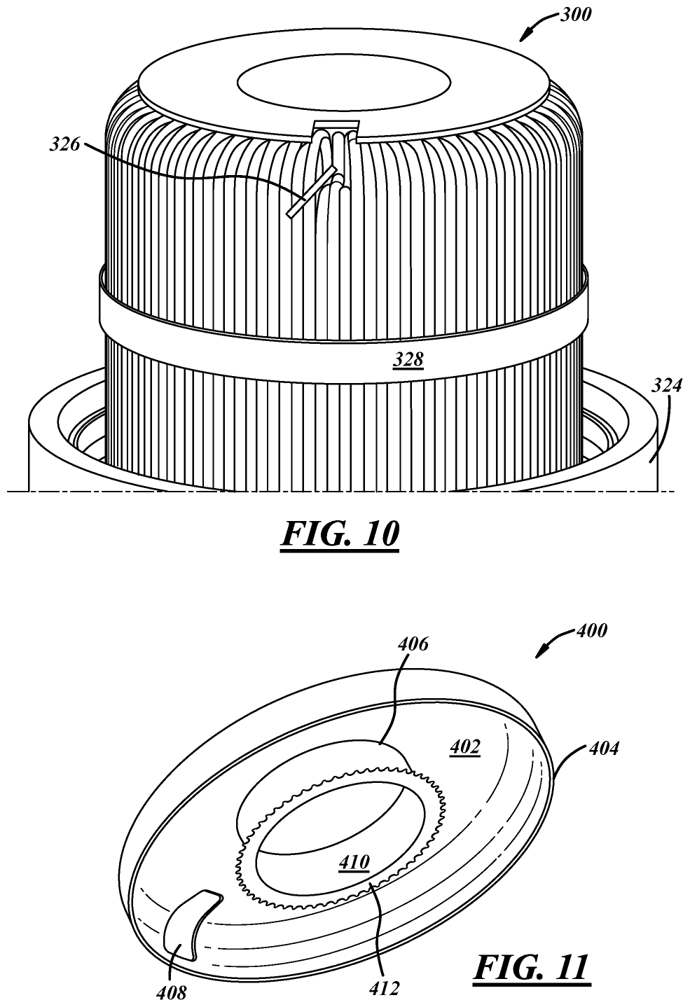

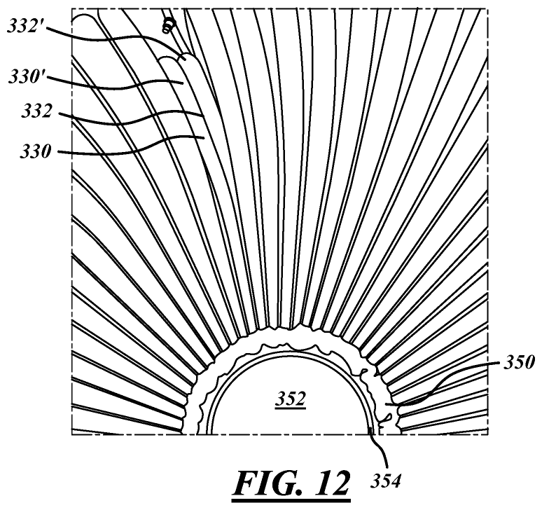

Referring now to FIG. 10, a view of tubes with cap 300 over the top of the tubes. An ignitor 326 is placed near cut out 314. An additional feature is shown in FIG. 10 that helps to retain the tubes in their desired positions in the form of a band 328.

In some applications, cap 300 allows for the placement of ignitor 326 as shown, i.e., near the shorter tubes. Also, cap 300 covers gaps in the U-shaped portions of the pluralities of tubes that in some applications exceeds the desired gap. In such situations, cap 300 can prevent flashback.

Referring not to FIG. 11, an alternative cap 400 is shown. Covering 402 has an outside end 404 and an inside edge 406. A cylindrical portion 410 of the cap has a notched portion. The notches are arranged to engage with tubes of the tubular reactor. Covering 402 is curved to wrap around the tubes more closely than cap 300 of FIG. 8. Covering 402 also includes a cut out 408 for an ignitor (not shown).

In the embodiments in FIG. 2 and, more particularly, in FIG. 4, portions 142 and 144 are bent to account for other features of the apparatus into which the tubular reactor is installed. In some situations, the gaps between adjacent tubes, due to the bends is greater than the desired gap to avoid flashback. To prevent such flashback, insulation 350 is placed against portions 142 and 144 of the tubes and insulation is also at the bottom of the tubes. The insulation is refractory material such as fiberglass, ceramic fiber, or any suitable material. A ring 354 is put in place to hold insulation 350 and 352 in place.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A heat pump, comprising:
a hot cylinder with a hot displacer disposed therein;
a cold cylinder with a cold displacer disposed therein;
a mechatronics section located between the hot and cold cylinders;
a dome disposed on one end of the hot cylinder;
a cap disposed on one end of the cold cylinder;
a hot chamber delimited by the dome, the hot cylinder, and the hot displacer;
a warm-hot chamber delimited by the mechatronics section, the hot cylinder, and the hot displacer;
a cold chamber delimited by the cap, the cold cylinder, and the cold displacer; and
a warm-cold chamber delimited by the mechatronics section, the cold cylinder, and the cold displacer wherein the warm-cold chamber and the warm-hot chamber are fluidly coupled via a temperature barrier chamber.

2. The heat pump of claim 1, further comprising:
a hot heat exchanger fluidly coupled to the hot chamber;
a hot regenerator fluidly coupled to the hot heat exchanger; and
a warm-hot heat exchanger fluidly coupled to the hot regenerator wherein:
the warm-hot heat exchanger is also fluidly coupled to the temperature barrier chamber.

3. The heat pump of claim 1, further comprising:
a cold heat exchanger fluidly coupled to the cold chamber;
a cold regenerator fluidly coupled to the cold heat exchanger; and
a warm-cold heat exchanger fluidly coupled to the cold regenerator wherein:
the warm-cold heat exchanger is also fluidly coupled to the temperature barrier chamber.

4. The heat pump of claim 2 wherein:
two fluids flow through the warm-hot heat exchanger: a working fluid and a liquid coolant;
the working fluid is a gas that is disposed within the heat pump; and
the liquid coolant enters the warm-hot heat exchanger via an inlet port that pierces a housing of the heat pump and the liquid coolant exits the warm-hot heat exchanger via an outlet port that pierces the housing of the heat pump.

5. The heat pump of claim 2 wherein:
two fluids flow through the warm-cold heat exchanger: a working fluid and a liquid coolant;
the working fluid is a gas that is disposed within the heat pump; and
the liquid coolant enters the warm-cold heat exchanger via an inlet port that pierces a housing of the heat pump and the liquid coolant exits the warm-cold heat exchanger via an outlet port that pierces the housing of the heat pump.

6. The heat pump of claim 1 wherein the temperature barrier chamber comprises a plurality of passages.

7. The heat pump of claim 1 wherein the temperature barrier chamber comprises a chamber with a porous media disposed therein.

8. The heat pump of claim 1, wherein the temperature barrier chamber comprises a passage with a free-floating piston disposed therein.

9. The heat pump of claim 1, further comprising:
a warm-hot heat exchanger wherein the warm-hot heat exchanger and the temperature barrier chamber are both fluidly coupled to the warm-hot chamber; and
a warm-cold heat exchanger wherein the warm-cold heat exchanger and the temperature barrier chamber are both fluidly coupled to the warm-cold chamber.

10. The heat pump of claim 3, further comprising:
a first external heat exchanger accepting a first fluid stream from the warm-hot heat exchanger and returning the first fluid stream to the warm-hot heat exchanger; and
a second external heat exchanger accepting a second fluid stream from the warm-cold heat exchanger and returning the second fluid stream to the warm-cold heat exchanger.

11. The heat pump of claim 3, further comprising:
a valve accepting a fluid stream from the warm-hot heat exchanger;
a first external heat exchanger fluidly coupled to the valve;
a second external heat exchanger fluidly coupled to the valve; and
a bypass pipe coupling an outlet pipe of the warm-cold heat exchanger to an inlet pipe of the warm-hot heat exchanger.

12. The heat pump of claim 11 wherein the valve is a first valve, the heat pump further comprising:
a building in which the heat pump is installed;
a second valve accepting a fluid stream from the cold heat exchanger;
a third external heat exchanger fluidly coupled to the second valve; and
a fourth external heat exchanger fluidly coupled to the second valve, wherein:
the first and third heat exchangers are located within the building; and
the second and fourth heat exchangers are located outside the building.
